(19) United States
(12) Patent Application Publication
(10) Pub. No.: US 2016/0078392 A1
(43) Pub. Date: Mar. 17, 2016

(54) METHOD AND SYSTEM FOR RECOMMENDING CROWDSOURCABILITY OF A BUSINESS PROCESS

(71) Applicant: Xerox Corporation, Norwalk, CT (US)

(72) Inventors: Sujit GUJAR, Bangalore (IN); Shourya ROY, Bangalore (IN); Chithralekha BALAMURUGAN, Pondicherry (IN); Jacki ONEILL, Grenoble (FR); Meera SAMPATH, Rochester, NY (US)

(21) Appl. No.: 14/952,528

(22) Filed: Nov. 25, 2015

Related U.S. Application Data
(63) Continuation of application No. 13/592,710, filed on Aug. 23, 2012, now abandoned.

(51) Int. Cl. G06Q 10/06; G06Q 50/00

(52) U.S. Cl. CPC G06Q 10/063112; G06Q 50/01

(57) ABSTRACT

A method and system for recommending suitability of crowdsourcing a business process is provided. The method includes generating a plurality of business requirements pertaining to the business processes, and receiving one or more attributes pertaining to one or more sets of crowdsourced workforce. The method further includes generating at least one of a comparison matrix or an optimization function based on the plurality of business requirements and the one or more attributes pertaining to one or more sets of crowdsourced workforce. Lastly, the method provides a recommendation on the suitability of crowdsourcing the business process based on at least one of the comparison matrix or the optimization function.

### TECHNICAL FIELD

The presently disclosed embodiments are related to a crowdsourcing process. More particularly, the presently disclosed embodiments are related to method and system for recommending crowdsourcability of a business process.

### BACKGROUND

Crowdsourcing has emerged over the last few years as an important labor pool for a business process. The primary factors for crowdsourcing a business process are controlling and reducing operating costs, non-availability of internal resources to handle certain operations, 24/7 access, and better turnaround time. Majority of crowdsourcing decisions are based on a cost benefit analysis, however, it could be possible that the crowdsourced workforces may not be suitable for completing tasks that are sent to them in a manner that meets all the requirements of the given business process. Hence, there is a need for a technique to identify the most suitable crowdsourced workforce for a given business process.

### SUMMARY

According to embodiments illustrated herein, there is provided a computer implementable method for recommending the suitability of crowdsourcing a business process. The computer implementable method includes a step of receiving a plurality of business requirements pertaining to the business process. The computer implementable method further includes a step of receiving one or more attributes pertaining to one or more sets of crowdsourced workforce. The computer implementable method further includes a step of generating a comparison matrix based on the plurality of business requirements and the one or more attributes pertaining to the one or more sets of crowdsourced workforce. The computer implementable method further includes a step of ranking each one of the one or more sets of crowdsourced workforce based on the comparison matrix and in the final step providing a recommendation on the suitability of crowdsourcing the business process based on the ranking.

According to embodiments illustrated herein, there is provided a computer implementable method for recommending the suitability of crowdsourcing a business process. The computer implementable method includes a step of receiving a plurality of business requirements pertaining to the business process. The computer implementable method further includes a step of assigning a tolerance value to each of the plurality of business requirements. The computer implementable method further includes a step of receiving one or more attributes pertaining to one or more sets of crowdsourced workforce. The computer implementable method further includes a step of generating an optimization function based on the plurality of business requirements, and the tolerance value assigned to each of the plurality of business requirements. The computer implementable method further includes a step of providing a recommendation on the suitability of crowdsourcing the business process based on the optimization function.

According to embodiments illustrated herein, there is provided a system for recommending the suitability of crowdsourcing a business process. The system includes a comparator module and a recommender module. The comparator module is configured for comparing a plurality of business requirements against one or more attributes pertaining to one or more sets of crowdsourced workforce. The comparator module is further configured to rank the one or more crowdsourced workforce based on the comparison. Lastly, the recommender module is configured for recommending the suitability of crowdsourcing the business process based on the ranking.

According to embodiments illustrated herein, there is provided a system for recommending the suitability of crowdsourcing a business process. The system includes an optimization module and a recommender module. The optimization module is configured for creating an optimization function based on a plurality of business requirements and a tolerance value for each of the plurality of business requirements. The recommender module is configured for recommending the suitability of crowdsourcing the business process based on the optimization function.

According to embodiments illustrated herein, there is provided a computer program product for recommending the suitability of crowdsourcing a business process. The computer program code includes program instruction means for receiving a plurality of business requirements pertaining to the business process. The computer program code further includes program instruction means for receiving one or more attributes pertaining to one or more sets of crowdsourced workforce. The computer program code further includes program instruction means for generating a comparison matrix based on the plurality of business requirements and the one or more attributes pertaining to one or more sets of crowdsourced workforce. The computer program code further includes program instruction means for ranking each one of the one or more sets of crowdsourced workforce based on the comparison matrix. Lastly, the computer program code further includes program instruction means for providing a recommendation on the suitability of crowdsourcing the business process based on the ranking.

According to embodiments illustrated herein, there is provided a computer program product for recommending the suitability of crowdsourcing a business process. The computer program code includes program instruction means for receiving a plurality of business requirements pertaining to the business process. The computer program code further includes program instruction means for assigning a tolerance value to each of the plurality of business requirements. The computer program code further includes program instruction means for receiving one or more attributes pertaining to one or more sets of crowdsourced workforce. The computer program code further includes program instruction means for generating an optimization function based on the plurality of business requirements, and the tolerance value assigned to each of the plurality of business requirements. Lastly, the computer program code further includes program instruction means for providing a recommendation on the suitability of crowdsourcing the business process based on the optimization function.

### BRIEF DESCRIPTION OF DRAWINGS

The accompanying drawings illustrate various embodiments of systems, methods, and embodiments of various other aspects of the invention. Any person with ordinary skills in the art will appreciate that the illustrated element boundaries (e.g., boxes, groups of boxes, or other shapes) in the figures represent one example of the boundaries. In a few examples, one element may be designed as multiple elements or multiple elements may be designed as one element. In a few examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram illustrating a system in accordance with at least one embodiment;

FIG. 2 is a block diagram illustrating a plurality of business requirements in accordance with at least one embodiment;

FIG. 3 is a comparison matrix that illustrates “Boolean output” in accordance with at least one embodiment;

FIG. 4 is a comparison matrix that illustrates “Score output” in accordance with at least one embodiment;

FIG. 5 is a block diagram illustrating a system in accordance with at least one embodiment;

FIG. 6 is a flow diagram that illustrates a computer implementable method for providing recommendation on the suitability of a business process in accordance with at least one embodiment;

FIG. 7 is a flow diagram that illustrates a computer implementable method for providing recommendation on the suitability of a business process in accordance with at least one embodiment; and

FIG. 8 is a flow diagram that illustrates a computer implementable method for providing recommendation on the suitability of a business process in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are for explanatory purposes, as methods and systems may extend beyond the described embodiments. For example, the teachings presented and the needs of a particular application may yield multiple alternate and suitable approaches to implement functionality of any detail described herein. Therefore, any approach may extend beyond the particular implementation choices in the following embodiments described and shown.

References to “one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### DEFINITION

The following terms shall have, for the purposes of this application, the respective meaning set forth below.

“Crowdsourcing” refers to distributing tasks by soliciting the participation of loosely defined groups of individual users. A group of users may include, for example, individuals responding to a solicitation posted on a certain website such as Amazon Mechanical Turk and Crowd Flower.

“Business process” refers to a process that includes plurality of tasks, or one or more activities that a business implements in order to achieve a specific business result.

“Business requirement” refers to a set of requirements, such as cost, job completion time, output quality, accuracy, or any other requirement associated with the business process.

“Crowdsourced workforce” refers to a workforce/worker(s) that may perform one or more tasks, which generate data that contribute to a defined result such as proofreading a part of a digital version of an ancient text or analyzing a quantum of a large volume of data. Each crowdsourced workforce is further compensated for the contribution on the task. According to the present disclosure, the crowdsourced workforce includes, but is not limited to, a satellite centre employee, a rural BPO (Business Process Outsourcing) firm employee, a home-based employee, or an internet-based employee. Hereinafter, “crowdsourced workforce”, “crowdworker”, and “crowd” may be interchangeably used.

As used herein, the terms such as optimization, optimal, and optimized shall be construed as relating to a preferred value or decision in a given set of known or unknown practical circumstances, and should not be construed as requiring a mathematically provable optimum of any value or decision.

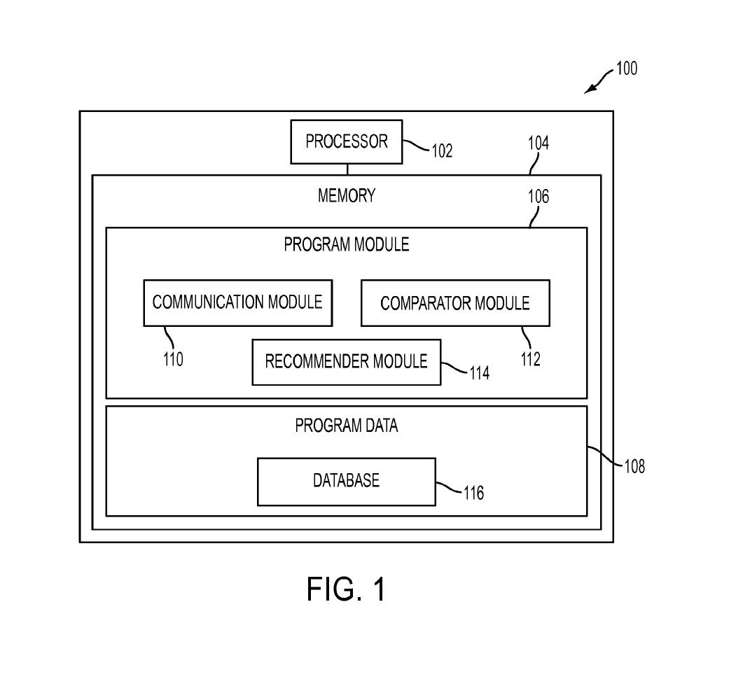

FIG. 1 is a block diagram illustrating a system for determining crowdsourcability of a business process in accordance with at least one embodiment. The system 100 includes a processor 102 and a memory 104. The processor 102 is coupled with the memory 104. In an embodiment, the system 100 corresponds to a computing device such as a Personal Digital Assistant (PDA), a smartphone, a tablet PC, a laptop, a personal computer, a mobile phone, and a Digital Living Network Alliance (DLNA)-enabled device.

The processor 102 is configured to execute a set of instructions stored in the memory 104. The processor 102 can be realized through a number of processor technologies known in the art. Examples of the processor can be an X86 processor, a RISC processor, an ASIC processor, a CISC processor, or any other processor. The processor 102 gathers the set of instructions from the memory 104 and executes the set of instructions.

The memory 104 is configured to store the set of instructions or modules. Some of the commonly known memory implementations can be, but are not limited to, a Random Access Memory (RAM), a Read-Only Memory (ROM), a Hard Disk Drive (HDD), and a secure digital (SD) card. The memory 104 includes a program module 106 and a program data 108. The program module 106 includes a set of instructions that can be executed by the processor 102 to perform specific actions on the system 100. The program module 106 includes a communication module 110, a comparator module 112, and a recommender module 114, and the program data 108 includes a database 116.

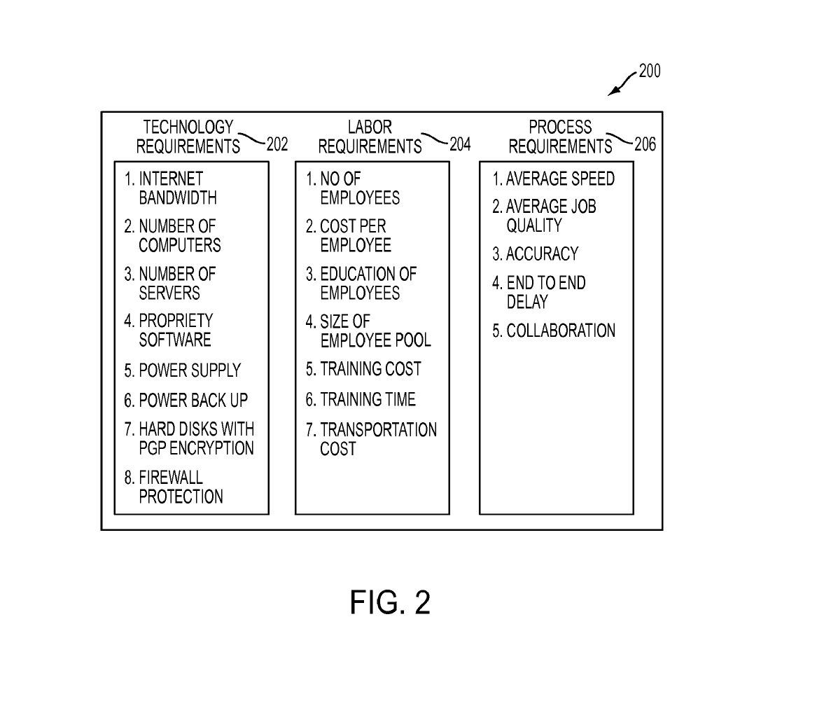

The communication module 110 is configured to receive a plurality of business requirements pertaining to the business process from the database 116. The plurality of business requirements pertaining to the business process is further explained in conjunction with FIG. 2.

FIG. 2 is a block diagram illustrating the plurality of business requirements 200 in accordance with at least one embodiment. The plurality of business requirements 200 includes, but is not limited to, a technology requirement 202, a labor requirement 204, and a process requirement 206. The technology requirement 202 of the business process includes one or more of internet bandwidth, number of computers, number of servers, propriety software, power supply, power back up, access card protected, hard disks with PGP encryption, firewall protection, or the like. The labor requirement 204 of the business process includes one or more of number of employees, cost per employee, education of employee, size of employee pool, training cost, training time, transportation cost, employee skill set such as typing speed, language, domain knowledge, or the like. The process requirement 206 of the business process includes one or more of average speed, average job quality, accuracy, end-to-end delay, collaboration, or the like. It will be understood by a person having ordinary skills in the art that the above described business requirements are not limited and may vary depending on the nature and type of the business process. Each of the plurality of business requirements 200 has a numeric representation For example; a value or a quantity of each of the plurality of business requirements 200 is represented by a real number.

The communication module 110 is further configured to receive one or more attributes pertaining to one or more sets of crowdsourced workforce from the database 116. The crowdsourced workforce can include one or more of a satellite centre, a rural BPO, a home employee, and a contract worker. Each set of the crowdsourced workforce has its own set of attributes such as defined skill profiles or number of workers available. In an embodiment, the communication module 110 is configured to receive one or more attributes pertaining to the one or more sets of crowdsourced workforce from the crowdsourcing platform such as Amazon Mechanical Turk and Crowd Flower. In an embodiment, each of the attributes pertaining to the crowdsourced workforce has a numeric representation (for example, a value of each of the attribute is represented by a real number).

The comparator module 112 is configured to establish and maintain communication with the communication module 110 and the recommender module 114 of the system 100. The comparator module 112 receives the plurality of business requirements 200 and one or more attributes of the crowdsourced workforce from the database 116 and compares the plurality of business requirements 200 against the one or more attributes of the one or more sets of the crowdsourced workforce through an operation analogous to matrix multiplication. In an embodiment, the comparison of the plurality of business requirements 200 of the business process with the one or more attributes of the one or more sets of crowdsourced workforce is done based on one or more comparison techniques. One or more comparison techniques include, but are not limited to, a comparator operator-based approach with “Boolean” output, a comparator operator-based approach with “score” output, or the like.

The comparator operator-based approach with “Boolean” output performs a comparison between the plurality of business requirements 200 and one or more attributes of the crowdsourced workforce to provide the Boolean output represented by 0 (zero) and 1 (one). The Boolean output is 0 when the plurality of business requirements 200 does not match with the one or more attributes of the crowdsourced workforce and the Boolean output is 1 when the plurality of business requirements 200 matches with the one or more attributes of the crowdsourced workforce.

In an embodiment, the comparator operator-based approach with the Boolean output uses a multi-attribute matching technique to perform the comparison between the plurality of business requirements 200 and the one or more attributes of the crowdsourced workforce. In an embodiment, two commonly known multi-attribute matching techniques such as “Satisfaction” technique and “Additive” technique are used to perform the comparison between the plurality of business requirements 200 and the one or more attributes of the crowdsourced workforce. It will be understood by a person with ordinary skills in the art that the above-disclosed multi-attribute matching techniques are provided as examples and is not meant to limit the scope of the disclosed embodiments.

In an embodiment, the comparator operator-based approach with the Boolean output defines a comparator operator (COMP) that operates on a vector R (the plurality of business requirements 200) and a matrix P (one or more attributes of crowdsourced workforce) to generate a comparison matrix with the Boolean output.

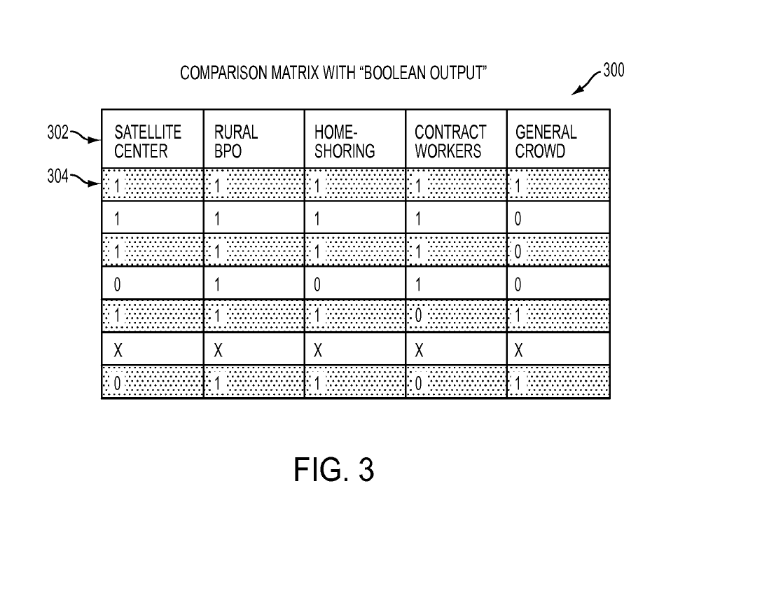

The comparison matrix with the Boolean output will now be explained in conjunction with FIG. 3. FIG. 3 illustrates the comparison matrix 300 showing the Boolean output result of the comparison between R and P.

For the simplicity of explanation, the comparison matrix 300 with the Boolean output generated by the comparator module 112 will be represented by M.

M=R COMP P

where, the plurality of the business requirements 200 is specified in terms of a vector R=[rⱼ] where j=1, n.

In an embodiment, let C₁, C₂, . . . C_{L} represent a set of L crowdsourced workforce that are potential candidates for crowdsourcing the business process specified by the plurality of business requirements 200. Each of the crowdsourced workforce has one or more attributes to offer against the plurality of the business requirements 200, and the attributes of the crowdsourced workforce is represented by a matrix P=[pᵢ^{j}], where the jth column represents the attributes of crowd Cj.

The crowdsourcability of the business process is determined based on the comparison that shows if the given crowdsourced workforce Cj with a set of attributes [pᵢ^{j}] can execute the given business process such that all of the plurality of business requirements R [rⱼ] 200 can be met.

In the comparison matrix (M) 300 (as shown in FIG. 3) representing the comparison results between R and P, a row 302 lists the crowdsourced workforces such as Satellite center, Rural BPO, Home-shoring, Contract Workers, and General Crowd. A row 304 lists the Boolean output for each of the crowdsourced workforces listed in the row 302. The Boolean output for each of the crowdsourced workforces listed in the row 302 is equal to 1, if P matches or is better than R and the Boolean output is equal to 0 otherwise. For example, if R is equal to 20 computers and P is equal to 20 or more computers, the output will be represented as 1, whereas if P is less than 20 computers, the output will be represented as 0.

In an embodiment, the comparator operator-based approach with “Score” output performs a comparison between the plurality of the business requirements 200 and the one or more attributes of the crowdsourced workforce to provide the Score output.

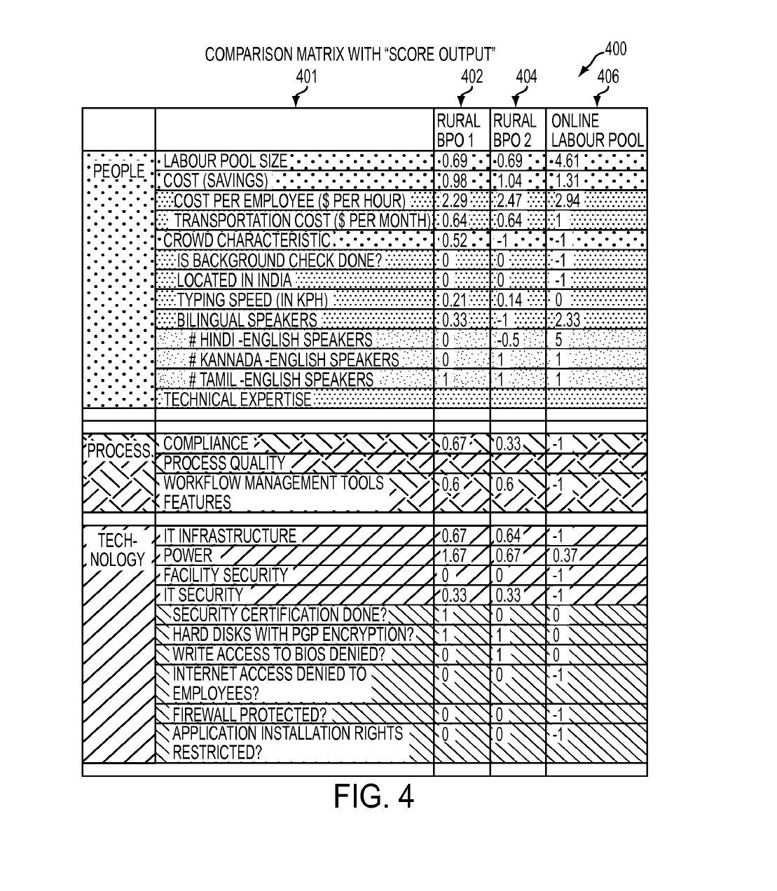

The comparison matrix with the Score output will now be explained in conjunction with FIG. 4. FIG. 4 represents the comparison matrix 400 showing the result of the comparison between R and P as score output. In the comparison matrix 400 having the score output, column 401 represents the plurality of business requirements 200, and column 402, 404, and 406 represents the crowdsourced workforces such as Rural BPO 1, Rural BPO 2, and online labor pool, respectively. In an embodiment, the score output could be a rational number, and each of the plurality of the business requirements 200 and attributes have a numerical representation.

The score output represents the output as zero (0) when one or more attributes of the crowdsourced workforce is equal to the plurality of the business requirements 200. For example, if one business requirement of the plurality of the business requirements 200 is of 20 PCs and the crowdsourced workforce or the crowdsourcing platform has 20 PCs, the output will be represented as 0. The score output further represents the output as greater than one (1) and less than one (1) depending on the degree of matching of the plurality of the business requirements 200 with the one or more attributes of the crowdsourced workforce. The degree of matching specifies that if the one or more attributes of the crowdsourced workforce is greater than the plurality of the business requirements 200, the score output is greater than 1. The degree of matching further specifies that if the one or more attributes of the crowdsourced workforce is less than the plurality of the business requirements 200, the score output is less than 1. If the attributes of the crowdsourced workforce are equal or greater than the plurality of the business requirements 200, it indicates that the attributes of the crowdsourced workforce suits perfectly and the business process can be crowdsourced to the set of suitable crowdsourced workforce (or the group of crowd workers). For example, if one business requirement of the plurality of the business requirements 200 is of 20 PCs and the crowdsourced workforce or the crowdsourcing platform has more than 20 PCs, the score output will be greater than one. If the crowdsourced workforce or the crowdsourcing platform has less than 20 PCs, the score output will be less than one.

As shown in FIG. 4, the Rural BPO 1 402 output for the labor pool size requirements (as shown in column 401) is 0.69. The score output of 0.69 indicates that the Rural BPO 1 402 has less than the required number of labor pool size. Rural BPO 2 404, and online labor pool 406 output for the labor pool size requirements is 0.69 and 4.63 respectively, which indicates that the Rural BPO2 404 too have labor pool less than the required number of labor pool size and only the online labor pool 406 have larger pool size than what is required.

In an embodiment, the comparator operator-based approach with score output defines a comparator function that operates on R (the plurality of business requirements 200) and P (attributes of crowdsourced workforce).

In an embodiment, for the simplicity of explanation, the comparator function is represented as: COMP=log (P/R).

In another embodiment, COMP=log (P−R)/R.

In yet another embodiment, COMP=log (P−R).

It will be understood by a person having ordinary skills in the art that COMP is not limited to above specified formulae and can vary depending on the nature/type of the R.

The comparator module 112 is further configured to rank the one or more suitable set of crowdsourced workforces based on the results of the comparison between the plurality of business requirements 200 and the attributes of the one or more sets of the crowdsourced workforces. The rank is assigned to the suitable set of crowdsourced workforce based on pre-defined criteria. The pre-defined criteria includes rules according to which each of the suitable set of crowdsourced workforce is assigned a numerical value on the basis of the degree of matching of the attributes of the crowdsourced workforce with the given business requirements from the plurality of business requirements 200 of the business process to be crowdsourced. The numerical value assigned to the each of the suitable set of crowdsourced workforce defines a rank number for each of the suitable set of crowdsourced workforce.

The recommender module 114 is configured to establish and maintain communication with the comparator module 112. Further, the recommender module 114 is configured for recommending the suitability of crowdsourcing the business process based on the ranking of the suitable crowdsourced workforces obtained from the comparator module 112 based on the comparison matrix 300/400.

In an embodiment, the database 116 corresponds to a storage device that stores data required for determining suitability of crowdsourcing the business process. The database 116 stores the plurality of business requirements 200 including the technology requirements 202, the labor requirements 204, and the process requirements 206. The database 116 is further configured to store one or more attributes corresponding to the one or more sets of crowdsourced workforces including the skill profile for each crowdsourced workforce. The database 116 can be implemented by using several technologies that are well known to those skilled in the art. Some examples of technologies may include, but are not limited to, MySQL® and Microsoft SQL®. In an embodiment, the database 116 may be implemented as cloud storage. Examples of cloud storage may include, but are not limited to, Amazon E3® and Hadoop® distributed file system.

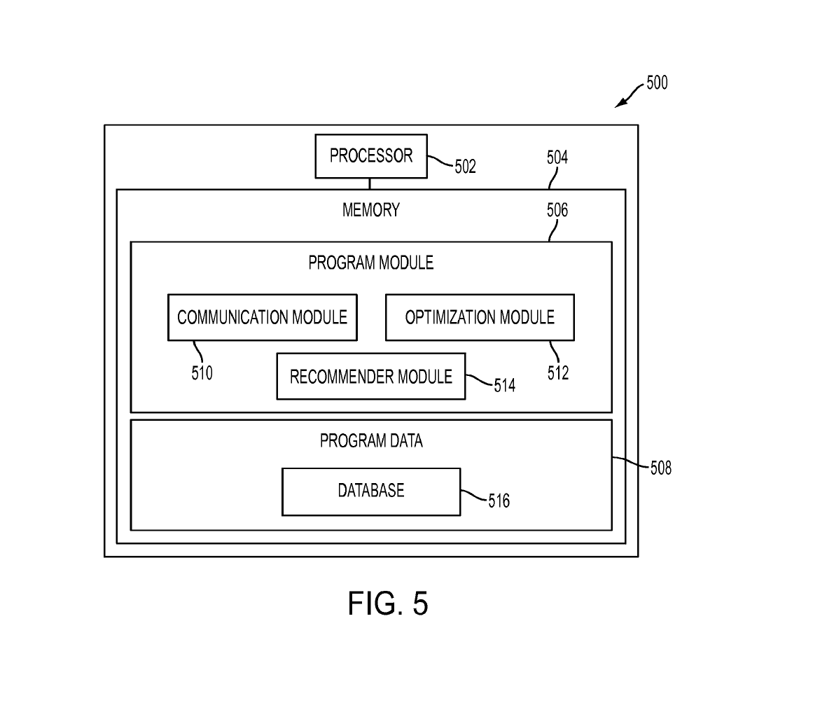

FIG. 5 is a block diagram illustrating a system for determining crowdsourcability of a business process in accordance with at least one embodiment. The system 500 includes a processor 502 and a memory 504. The processor 502 is coupled with the memory 504. In an embodiment, the system 500 corresponds to a computing device such as a Personal Digital Assistant (PDA), a smartphone, a tablet PC, a laptop, a personal computer, a mobile phone, and a Digital Living Network Alliance (DLNA)-enabled device.

The processor 502 is configured to execute a set of instructions stored in the memory 504. The processor 502 can be realized through a number of processor technologies known in the art. Examples of the processor can be an X86 processor, a RISC processor, an ASIC processor, a CISC processor, or any other processor. The processor 502 gathers the set of instructions from the memory 504 and executes the set of instructions.

The memory 504 is configured to store the set of instructions or modules. Some of the commonly known memory implementations can be, but are not limited to, a Random Access Memory (RAM), a Read-Only Memory (ROM), a Hard Disk Drive (HDD), and a secure digital (SD) card. The memory 504 includes a program module 506 and a program data 508. The program module 506 includes a set of instructions that can be executed by the processor 502 to perform specific actions on the system 500. The program module 506 includes a communication module 510, an optimization module 512, and a recommender module 514, and the program data 508 includes a database 516.

The communication module 510 is configured to receive a plurality of business requirements pertaining to the business process from the database 516. The plurality of business requirements pertaining to the business process has been explained in conjunction with FIG. 2.

The communication module 510 is further configured to receive one or more attributes pertaining to one or more sets of crowdsourced workforce from the database 516. The crowdsourced workforce can include one or more of a satellite centre, a rural BPO, a home employee, and a contract worker. Each set of the crowdsourced workforce has its own set of attributes such as defined skill profiles or number of workers available. In an embodiment, the communication module 510 is configured to receive one or more attributes pertaining to the one or more sets of crowdsourced workforce from the crowdsourcing platform such as Amazon Mechanical Turk and Crowd Flower. In an embodiment, each of the attributes pertaining to the crowdsourced workforce has a numeric representation (for example, a value of each of the attribute is represented by a real number).

The optimization module 512 is configured to establish and maintain communication with the communication module 510 and the recommender module 514 of the system 500. In an embodiment, the optimization module 512 is configured to generate an optimization function. In another embodiment, the optimization module 512 does not generate the optimization function and is only configured to use a pre-defined optimization function. The optimization function includes a number of variables. The number of variables includes a plurality of the business requirements 200 (as described in FIG. 2), including skill profiles, deadlines, or costs. Each of the variables of the optimization function is further assigned a tolerance value.

In an embodiment, the optimization function is considered for determining crowdsourcability of the business process. In another embodiment, the optimization function is considered for recommending crowdsourcability of the business process. The optimization function is defined for the business process to determine one optimal crowdsourced workforce suitable for working on the given business process. In another embodiment, the optimization function determines multiple (at least two) optimal crowdsourced workforces suitable for simultaneously working on the given business process. In yet another embodiment, the optimization function determines at least two optimal crowdsourced workforce between which the given business process could be split for parallel execution and thereby reduces overall business process completion time.

In an embodiment, the optimization function is generated by the optimization module 512 and is represented by F.

F=−0.6*COST+0.2*THROUGHPUT+0.2*ACCURACY

The above-defined optimization function includes variables such as cost, throughput, and accuracy. It will be understood by a person having ordinary skills in the art that the above-defined optimization function is not meant to limit the scope of the disclosed embodiments and any suitable set of variables can be used to define the optimization function.

The optimization function determines the suitable set of the crowdsourced workforce, that is, the one that maximizes the optimization function. It will be understood by a person having ordinary skills in the art that the set of crowdsourced workforce that maximizes the optimization function will meet the plurality of business requirements 200 within tolerance limits. In an embodiment, the optimization function F is solved using standard optimization techniques such as simplex methods and implemented using standard optimization packages such as Microsoft Excel Solver.

In an embodiment, F is maximized to determine one optimal crowdsourced workforce suitable for working on the given business process.

COMPᵢ(rᵢ,pᵢ^{j})*xⱼ>=−εᵢ*xⱼ for all i,j MAXIMIZE F
Σ xⱼ=1
xᵢ=0 or 1

In an embodiment, rᵢs denotes the business requirements 200. Let C₁, . . . , C_{L}, represent L different set of “crowdsourced workforces” with attributes pᵢ^{j}. Let xⱼ be an indicator variable such that xⱼ=1, if crowd Cj gets the business process else is xⱼ=0. Let εᵢ represents tolerance value on requirement rᵢ. The tolerance value εᵢ=zero, if an administrator of the system 100 is only interested in determining whether the given business process is crowdsourcable or not, and is not interested in determining the optimal crowdsourced workforce that meets the plurality of the business requirements 200 within the defined tolerance values.

In an embodiment, the COMPᵢ(rᵢ,pᵢ^{j})*xⱼ>=−εᵢ*xⱼ implies that any set of crowdsourced workforces Cj capable of executing the business process should satisfy the business requirements 200 within the tolerance values. The constraint Σ xⱼ=1 implies that the business process is executed by one set of crowdsourced workforces only. Thus, the business process R=[rᵢ] is determined to be crowdsourcable if the above defined optimization function has a feasible solution with εᵢ=0.

In another embodiment, F is maximized to determine multiple crowdsourced workforces suitable for working on the given business process.

COMPᵢ(rᵢ,pᵢ^{j})*I_{{xj>0}}>=−εᵢ*I_{{xj>0}}for all i,j MAXIMIZE F
Σ xⱼ=1
1>=xᵢ>=0
   where xⱼ be the fraction of the work assigned to crowd Cj, and 0<=xⱼ<=1 with Σxⱼ=1. Thus, the process R=[rᵢ] is determined to be crowdsourcable if the above optimization function has a feasible solution with εᵢ=0.

In an embodiment, the optimization function F is configured to include the function of maximizing profit, therefore the optimal crowdsourced workforce is determined keeping in view the expected outcome quality along with maximizing profit.

The recommender module 514 recommends at least one optimal set of crowdsourced workforce from the one or more sets of the crowdsourced workforces suitable for working on the given business process to maximize profit and output quality. Thus, according to an embodiment, the recommender module 514 identifies whether a given business process is crowdsourcable to a given crowd or not. Further, the recommender module 514 indicates suitable crowdsourced workforce among the set of crowdsourced workforces that matches the plurality of business requirements 200 within the pre-specified tolerance values on the plurality of business requirements 200.

In an embodiment, the database 514 corresponds to a storage device that stores data required for determining suitability of crowdsourcing the business process. The database 516 stores the plurality of business requirements 200 including the technology requirements 202, the labor requirements 204, and the process requirements 206. The database 516 is further configured to store one or more attributes corresponding to the one or more sets of crowdsourced workforces including the skill profile for each crowdsourced workforce. The database 516 can be implemented by using several technologies that are well known to those skilled in the art. Some examples of technologies may include, but are not limited to, MySQL® and Microsoft SQL®. In an embodiment, the database 516 may be implemented as cloud storage. Examples of cloud storage may include, but are not limited to, Amazon E3® and Hadoop® distributed file system.

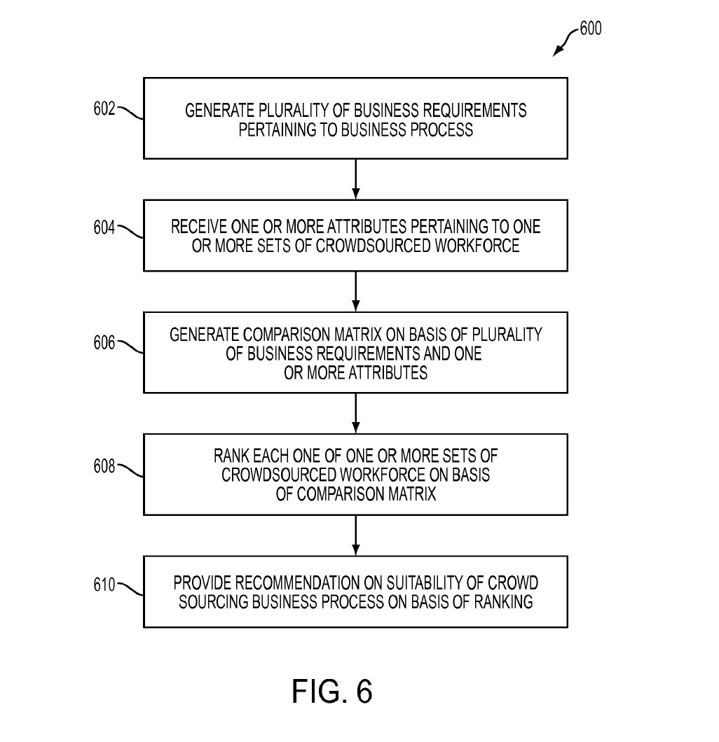

FIG. 6 is a flow diagram illustrating a computer implementable method for providing recommendation on the suitability of a business process in accordance with at least one embodiment.

At step 602, the plurality of the business requirements 200 is generated pertaining to the business process. In an embodiment, the plurality of the business requirements 200 is generated based on an input provided by an administrator of the system 100. In an embodiment, the administrator of the system 100 can be a manager or owner of the business process. In an alternate embodiment, the plurality of the business requirements 200 is generated in an automated manner. In an embodiment, the plurality of the business requirements 200 includes, but is not limited to, required skills, number of jobs, and the deadline to complete the job.

At step 604, one or more attributes pertaining to the one or more sets of crowdsourced workforce are received. In an embodiment, the one or more attributes are received by the communication module 110. In an embodiment, the one or more attributes include, but are not limited to, the skill profile of each crowd worker, or the like. In an embodiment, the one or more attributes is received by the communication module 110 from the crowdsourcing platforms such as Crowd Flower and Amazon Mechanical Turk, or any other internet/home-based marketplace.

At step 606, the comparison matrix (the comparison matrix 300 with Boolean output and/or the comparison matrix 400 with Score output) is generated based on the plurality of business requirements 200 and the one or more attributes pertaining to the one or more sets of crowdsourced workforce. In an embodiment, the comparator module 112 generates the comparison matrix (the comparison matrix 300 with Boolean output and/or the comparison matrix 400 with Score output). The comparison matrix (the comparison matrix 300 with Boolean output and/or the comparison matrix 400 with Score output) contains the results of the comparison between the business requirements 200 of the business process with one or more attributes of the crowdsourced workforces. The comparison between the plurality of business requirements 200 and the attributes of crowdsourced workforce is performed based on one or more pre-specified comparison techniques described in FIG. 1.

At step 608, each one of the one or more sets of crowdsourced workforce is ranked on basis of the comparison matrix (the comparison matrix 300 with Boolean output and/or the comparison matrix 400 with Score output). In an embodiment, the comparator module 112 determines and assigns the rank order of each of suitable crowdsourced workforce/crowdsourced workforces based on the one or more pre-specified ranking techniques. The ranking of the one or more set of crowdsourced workforce is assigned based on the degree of matching of the plurality of the business requirements 200 of the business process with one or more attributes of the crowdsourceable workforce/crowdsourced workforces. In an embodiment, the rank order is assigned in order of decreasing degree of matching. For example, if the business requirement is of 5 (five) scanning software, and there are 3 crowdsourced workforces with 2 (two), 3 (three), and 4 (four) scanning software, respectively, in this case the crowdsourced workforce with 2 scanning software will be ranked first and the crowdsourced workforce with 4 scanning software will be ranked at the bottom. In an alternate embodiment, the rank order is assigned in order of increasing degree of matching.

At step 610, recommendation on the suitability of crowdsourcing the business process is provided based on the ranking of the one or more sets of crowdsourced workforce. In an embodiment, the recommender module 114 provides the recommendation on the suitability of crowdsourcing the business process based on the ranking provided by the comparator module 112. In an embodiment, the recommendation on the suitability of crowdsourcing the business process is stored in the database 116. The process of providing recommendation has been explained in detail in conjunction with detailed description of FIG. 1.

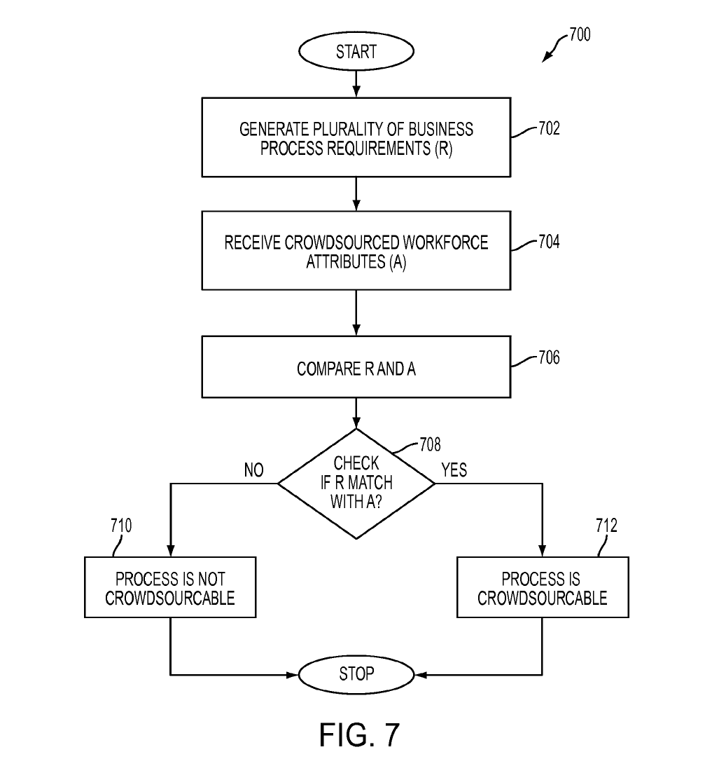

FIG. 7 is a flow diagram illustrating a computer implementable method for providing recommendation on the suitability of a business process in detail in accordance with at least one embodiment.

At step 702, the plurality of the business requirements 200 (R) associated with the business process is received by the communication module 110.

At step 704, one or more attributes (P) associated with the one or more sets of crowdsourced workforce/crowdsourced workforces are received by the communication module 110.

At step 706, the comparator module 112 compares the business requirements 200 (R) of the business process with the attributes (P) of the crowdsourced workforces. Each crowdsourced workforce has an attribute where each attribute is defined by a real number. The real number defines the attribute quantitatively. Further, each business process has the plurality of the business requirements 200 specified, where each business requirement of the plurality of business requirements 200 is also represented by the real number.

At step 708, the comparator module 112 checks whether the plurality of business requirements 200 (R) of the business process matches with the attributes (P) of the crowdsourced workforces or not. Since the plurality of the business requirements 200 (R) and the attributes (P) are represented by the real numbers, the comparison results are also represented by numerical real numbers. The comparison by the one or more comparison techniques is explained in conjunction with the FIG. 1.

If the attributes (P) of the crowdsourced workforces is found to be less than the plurality of business requirements 200 (R) of the business process at step 608, the step 610 is followed. At step 610, it is determined that the business process will not be crowdsourceable.

If the attributes (P) of the crowdsourced workforces is found to be greater than the plurality of the business requirements 200 (R) of the business process at step 608, the step 612 is followed. At step 612, it is determined that the business process will be crowdsourceable.

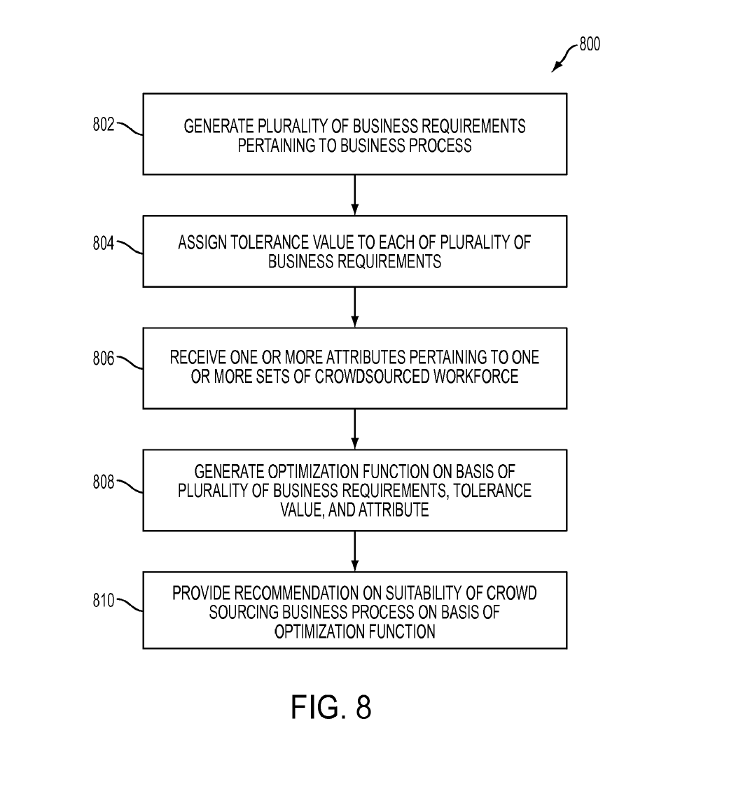

FIG. 8 is a flow diagram illustrating the steps of a computer implementable method for providing recommendation on the suitability of a business process in accordance with an embodiment.

At step 802, the plurality of the business requirements 200 is received pertaining to the business process. In an embodiment, the plurality of the business requirements 200 is received by the communication module 510. In an embodiment, the plurality of the business requirements 200 include, but are not limited, to labor requirement, technology requirements, and process requirements. The labor requirements can include parameters such as size of labor, labor pool, labor cost, training cost, training time, transportation cost, or the like. The technology requirement group can include parameters such as number of computers, number of servers, power supply, firewall protection, internet connectivity and bandwidth, or the like. The process characteristic group can include parameters such as data integrity, quality assurance, workflow management tools, or the like.

At step 804, each of the business requirements 200 is assigned a tolerance value. The tolerance value further defines the acceptable range for each of business requirement to be matched with the attributes of the crowdsourcable workforce/crowdsourced workforces. In an embodiment, the tolerance value is represented by a real number.

At step 806, the one or more attributes pertaining to the one or more sets of crowdsourced workforce is received. In an embodiment, the one or more attributes is received from the communication module 510. In an embodiment, the one or more attributes include, but are not limited to, the skill profile of each crowdsourced workforce, or the like.

At step 808, an optimization function is generated based on the plurality of the business requirements 200 of the business process, where each of the business requirements 200 is assigned a tolerance value/limit. In an embodiment, the optimization function is generated by the optimization module 512. The optimization function includes a number of variables. Each variable corresponds to the one or more business requirements 200 including skill profile, deadline, cost, or the like. The defined optimization function determines the best set of crowdsourced workforce by solving the optimization function, that is, the one that maximizes the optimization function. In an alternate embodiment, the determination of the optimal set of crowdsourced workforce is performed by adjusting some of the variables of the optimization function as per the requirement. In yet another embodiment, the determination of the optimal set of crowdsourced workforce is performed by adjusting the tolerance values of the business requirements 200. In an embodiment, the optimization function is configured to include the function of maximizing profit, therefore the optimal levels of the suitable crowdsourced workforces is determined keeping in view the expected outcome quality along with maximizing profit.

At step 810, recommendation on the suitability of crowdsourcing the business process is provided based on the optimization function. In an embodiment, the recommender module 514 provides the recommendation on the suitability of crowdsourcing the business process based on the results upon solving the optimization function by the optimization module 512. In an embodiment, the recommendation is stored in the database 516.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as a floppy-disk drive or an optical-disk drive. The storage device may also be a means for loading computer programs or other instructions into the computer system. The computer system also includes a communication unit. The communication unit allows the computer to connect to other databases and the Internet through an Input/output (I/O) interface, allowing the transfer as well as reception of data from other databases. The communication unit may include a modem, an Ethernet card, or other similar devices, which enable the computer system to connect to databases and networks, such as, LAN, MAN, WAN, and the Internet. The computer system facilitates inputs from a user through input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer readable instructions may include various commands that instruct the processing machine to perform specific tasks such as steps that constitute the method of the disclosure. The method and systems described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in all operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, the system, and the computer program product, as described above, have numerous advantages. Some of these advantages may include, but are not limited to, reducing costs, increasing returns on investments, improving process performance, freeing up resources for other uses, converting fixed costs to variable costs, improving speed to market, 24/7 access to services, and better turnaround time of finished work products.

Various embodiments of the method and the system for determining the crowdsourcability of the business process have been disclosed. However, it should be apparent to those skilled in the art that many more modifications, besides those described, are possible without departing from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person with ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art, which are also intended to be encompassed by the following claims.

What is claimed is:

1.-22. (canceled)

23. A computer implemented method for crowdsourcing based on solving an optimization function, the computer implementable method comprising:
receiving, by one or more processors, a plurality of requirements comprising technology requirements, labor requirements, and process requirements;
assigning a tolerance value to each of the plurality of requirements;
receiving, by the one or more processors, one or more attributes pertaining to a plurality of crowdsourced workforces that include at least one workforce comprising a plurality of internet based home employees working on remote computing devices;
generating, by the one or more processors, an optimization function based on the plurality of requirements and assigned tolerance values, wherein the optimization function comprises variables corresponding to the plurality of requirements and one or more expressions for optimization;
solving the generated optimization function such that the one or more expressions are optimized based on the received attributes pertaining to the one or more sets of crowdsourced workforces; and
recommending at least one of the plurality of crowdsourced workforces based on the solving.

24. The computer implemented method of claim 23, wherein solving the generated optimization function comprises determining an optimal crowdsourced workforce from the plurality of crowdsourced workforces, and wherein the optimal crowdsourced workforce is recommended.

25. The computer implemented method of claim 23, further comprising recommending at least two of the plurality of crowdsourced workforces based on the solving.

26. The computer implemented method of claim 25, wherein solving the generated optimization function comprises determining an optimal combination of two crowdsourced workforces from the plurality of crowdsourced workforces, and wherein the combination of optimal crowdsourced workforces is recommended.

27. The computer implemented method of claim 26, wherein solving the generated optimization function is based on assigning a fraction of work to a first of the two crowdsourced workforces and a fraction of work to a second of the two crowdsourced workforces.

28. The computer implemented method of claim 23, wherein the optimization function is solved using mathematical solver software and simplex optimization techniques.

29. The computer implemented method of claim 23, wherein the assigned tolerance values are received along with the corresponding requirement.

30. The computer implemented method of claim 23, wherein the crowdsourced workforces comprise at least one of a satellite centre employee, a rural BPO (Business Process Outsourcing) firm employee, or an internet-based employee.

31. The computer implemented method of claim 23, wherein the labor requirements comprise at least one of size of labor pool, labor cost, training cost, training time, transportation costs, labor education, labor integrity, and labor retention.

32. The computer implemented method of claim 23, wherein the technology requirements comprise at least one of number of servers, number of computers, power supply, back-up supply, automation tools, internet connectivity, internet bandwidth, facility security, access card protection, hardware security features, PGP encrypted hard disk, BIOS read-only access, leased network, and firewall protection.

33. The computer implemented method of claim 23, wherein the process requirements comprise at least one of modular process elements, decoupled process elements, data integrity, compliance, quality insurance, and workflow management tools.

34. The computer implemented method of claim 23, further comprising generating, by the one or more processors, the plurality of requirements in an automated manner.

35. A system for crowdsourcing based on solving an optimization function, the system comprising:
one or more computer processors configured to:
receive a plurality of requirements comprising technology requirements, labor requirements, and process requirements;
assign a tolerance value to each of the plurality of requirements;
receive one or more attributes pertaining to a plurality of crowdsourced workforces that include at least one workforce comprising a plurality of internet based home employees working on a remote computing devices;
generate an optimization function based on the plurality of requirements and assigned tolerance values, wherein the optimization function comprises variables corresponding to the plurality of requirements and one or more expressions for optimization;
solve the generated optimization function such that the one or more expressions are optimized based on the received attributes pertaining to the one or more sets of crowdsourced workforces; and
recommend at least one of the plurality of crowdsourced workforces based on the solving.

36. The system of 35, wherein solving the generated optimization function comprises determining an optimal crowdsourced workforce from the plurality of crowdsourced workforces, and wherein the optimal crowdsourced workforce is recommended.

37. The system of claim 35, wherein the one or more processors are further configured to recommend at least two of the plurality of crowdsourced workforces based on the solving.

38. The system of claim 37, wherein solving the generated optimization function comprises determining an optimal combination of two crowdsourced workforces from the plurality of crowdsourced workforces, and wherein the combination of optimal crowdsourced workforces is recommended.

39. The system of claim 38, wherein solving the generated optimization function is based on assigning a fraction of work to a first of the two crowdsourced workforces and a fraction of work to a second of the two crowdsourced workforces.

40. The system of claim 35, wherein the optimization function is solved using mathematical solver software and simplex optimization techniques.

41. The system of claim 35, wherein the assigned tolerance values are received along with the corresponding requirement.

42. The system of claim 35, wherein the crowdsourced workforces comprise at least one of a satellite centre employee, a rural BPO (Business Process Outsourcing) firm employee, or an internet-based employee.
